(19) United States
(12) Patent Application Publication
(10) Pub. No.: US 2023/0339599 A1
(43) Pub. Date: Oct. 26, 2023

(54) FLIGHT STABILIZATION SYSTEM WITHOUT CROSS SHAFTS FOR VTOL TILTROTOR AIRCRAFT

(71) Applicant: Donatas Skulskis, Siauliu RAJ (LT)

(72) Inventor: Donatas Skulskis, Siauliu RAJ (LT)

(21) Appl. No.: 17/729,161

(22) Filed: Apr. 26, 2022

(51) Int. Cl. B64C 9/08; B64C 1/26; B64D 45/00; B64C 29/00; B64C 3/58; B64D 29/02; B64C 9/02

(52) U.S. Cl. CPC B64C 9/08; B64C 1/26; B64D 45/00; B64C 29/0008; B64C 3/58; B64D 29/02; B64C 9/02

(57) ABSTRACT

A stabilization system for an aircraft includes a rear stabilizer system. The rear stabilizer system is disposed in a rear portion of the fuselage of the aircraft. The rear stabilizer system includes a rear rudder having a tilt fan configured to generate lift. The rear stabilizer system is configured to detect a failure of an engine and activate an emergency mode. The instructions when executed cause the system to receive flight dynamics from an onboard sensor; determine an existence and a location of the engine failure; and send a signal to the rear rudder based on the existence and the location of the engine failure. The rear rudder engages in a first position. The first position generates counter-torque propulsion towards the engine that failed.

### TECHNICAL FIELD

The present disclosure relates to a stabilization system for an aircraft. More specifically, the present disclosure relates to a flight stabilization system with a fixed wing using tiltrotor fans, which is generally incorporated into a vertical take-off and landing (VTOL) aircraft.

### BACKGROUND

A vertical take-off and landing (VTOL) aircraft is an aircraft which is capable of taking off, hovering, and landing vertically. The current state of the art in VTOL propulsion encompasses various tiltrotor propulsion systems. VTOL tiltrotors are typically susceptible to aeroelastic instability due to the higher flight speeds over traditional VTOL such as helicopters. As such, ample propulsion and stabilization systems are required in the event of an engine failure. Various types of engine failures are known in the art, including one engine inoperative (“OEI”) mode (e.g., “one engine failure” (“OEF”) mode) and two engine inoperative (“TEI”) mode (e.g., “both engine failure” (“BEF”) or “both engine inoperative” (“BEI”) mode). Various flight stabilization systems and methods have been developed to counter aeroelastic instability through cyclic and pitch controls. However, these systems and methods lose scalability in larger aircraft, and are typically limited in safety capabilities. Overall, current systems and methods are heavy, complex, and costly. Accordingly, developments in efficient propulsion and stability for tiltrotor aircraft are needed.

### SUMMARY

Aspects of the present disclosure are described in detail with reference to the drawings wherein like reference numerals identify similar or identical elements.

In accordance with aspects of the disclosure, a stabilization system for an aircraft includes a rear stabilizer system configured to be disposed in a rear portion of a fuselage of an aircraft. The rear stabilizer system includes a rear rudder, a processor, and a memory. The rear rudder is configured to detect a failure of an engine and activate an emergency mode. The rear rudder includes a tilt fan configured to generate lift. The memory includes instructions, which when executed by the processor, causes the system to: receive flight dynamics from an onboard sensor, determine an existence and a location of the engine failure, and send a signal to the rear rudder based on the existence and the location of the engine failure. The rear rudder engages in a first position, which generates counter-torque propulsion towards the engine that failed.

In an aspect of the present disclosure, the aircraft may be a vertical take-off and landing (VTOL) aircraft.

In another aspect of the present disclosure, the engine failure may be a one engine inoperative (OEI) mode or a two engine inoperative (TEI) mode.

In yet another aspect of the present disclosure, propulsion may be generated by the tilt fan.

In a further aspect of the present disclosure, the rear stabilizer system may be configured to generate tandem propulsion and/or counter propulsion relative to the engine that failed.

In yet a further aspect of the present disclosure, the tilt fan may be configured to rotate through an arc length ranging from about zero degrees to about 180 degrees with respect to the rear rudder.

In an aspect of the present disclosure, the arc length may extend on an axis perpendicular to the rear rudder.

In another aspect of the present disclosure, the tilt fan may be capable of moving into a first position and a second position.

In yet another aspect of the present disclosure, the stabilization system may include a fixed wing disposed in a front portion of the fuselage of the aircraft. The fixed wing may include a wing tip including an engine nacelle configured for generating lift. The engine nacelle may include a rotor.

In a further aspect of the present disclosure, the engine nacelle may be configured to rotate through an arc length ranging from about zero degrees to about 90 degrees with respect to the fixed wing.

In yet a further aspect of the present disclosure, the arc length may extend on an axis perpendicular to the fixed wing.

In accordance with aspects of the disclosure, a computer-implemented method for a stabilization system for an aircraft includes receiving flight dynamics from an onboard sensor; determining an existence and location of a failure of an engine; and sending a signal to a rear rudder of the aircraft based on the existence and location of the engine failure, the rear rudder engaging in a first position generating counter-torque propulsion towards the engine that failed.

In an aspect of the present disclosure, the aircraft may be a vertical take-off and landing (VTOL) aircraft.

In another aspect of the present disclosure, the engine failure may be a one engine inoperative (OEI) mode or a two engine inoperative (TEI) mode.

In yet another aspect of the present disclosure, propulsion may be generated by the tilt fan.

In a further aspect of the present disclosure, the rear stabilizer system may be configured to generate tandem propulsion and/or counter propulsion relative to the engine that failed.

In yet a further aspect of the present disclosure, the tilt fan may be configured to rotate through an arc length ranging from about zero degrees to about 180 degrees with respect to the rear rudder.

In an aspect of the present disclosure, the arc length may extend on an axis perpendicular to the rear rudder.

In another aspect of the present disclosure, the tilt fan may be capable of moving into a first position and a second position.

In accordance with aspects of the disclosure, a non-transitory computer-readable storage medium storing a program for causing a controller to execute a method for flight stabilization includes receiving flight dynamics from an onboard sensor; determining an existence and location of a failure of an engine; and sending a signal to a rear rudder of the aircraft based on the existence and location of the engine failure, the rear rudder engaging in a first position generating counter-torque propulsion towards the engine that failed.

Further details and aspects of exemplary aspects of the present disclosure are described in more detail below with reference to the appended figures.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a top view of a stabilization system of an aircraft in accordance with the disclosure;

FIG. 2 is a top view of the stabilization system of the aircraft of FIG. 1 with tilt fans in alternative positions, in accordance with the disclosure;

FIG. 3 is a side perspective view of a stabilization system of an aircraft, in accordance with the disclosure;

FIG. 4 is a side perspective view of the stabilization system of the aircraft of FIG. 3, with engine nacelles and tilt fans in alternative positions, in accordance with the disclosure;

FIG. 5 is a top perspective view of the stabilization system of the aircraft of FIGS. 3-4, in accordance with the disclosure;

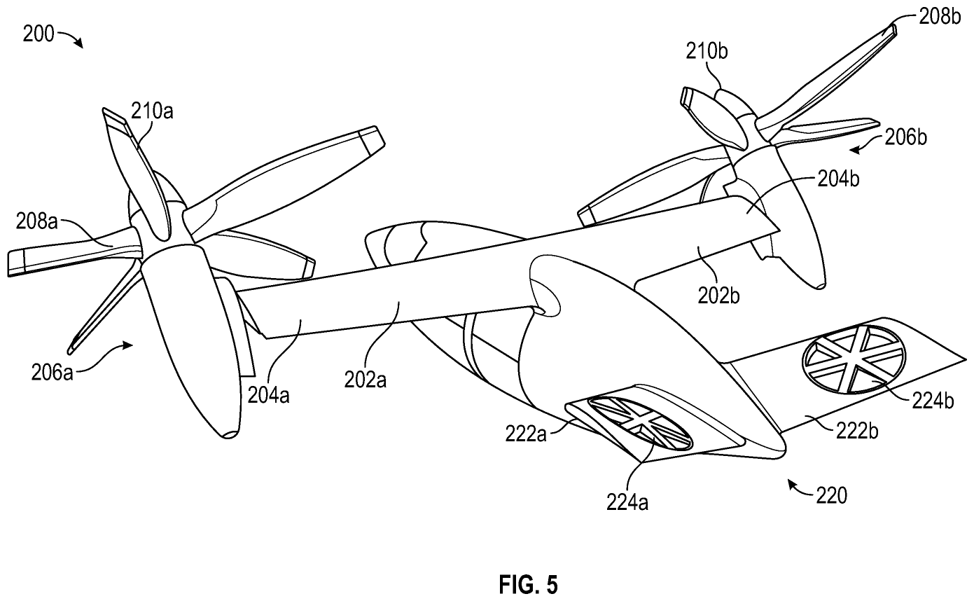

FIG. 6 is an enlarged view of a tilt fan in FIGS. 1-2, in accordance with the disclosure; and

FIG. 7 is a side perspective view of an aircraft in accordance with the disclosure.

Further details and aspects of exemplary aspects of the disclosure are described in more detail below with reference to the appended figures. Any of the above aspects and aspects of the disclosure may be combined without departing from the scope of the disclosure.

### DETAILED DESCRIPTION

The present disclosure relates to a stabilization system for an aircraft. More specifically, the present disclosure relates to a flight stabilization system with fixed wings using tiltrotor fans, which is generally incorporated into a vertical take-off and landing (VTOL) aircraft.

Although the present disclosure will be described in terms of specific aspects, it will be readily apparent to those skilled in this art that various modifications, rearrangements, and substitutions may be made without departing from the spirit of the present disclosure. The scope of the present disclosure is defined by the claims appended hereto.

For purposes of promoting an understanding of the principles of the present disclosure, reference will now be made to exemplary aspects illustrated in the drawings, and specific language will be used to describe the same. It will nevertheless be understood that no limitation of the scope of the present disclosure is thereby intended. Any alterations and further modifications of the inventive features illustrated herein, and any additional applications of the principles of the present disclosure as illustrated herein, which would occur to one skilled in the relevant art and having possession of this disclosure, are to be considered within the scope of the present disclosure.

The disclosed technology enables lighter construction than traditional methods. Further the disclosed technology has the benefit of less complex and less expensive components. The disclosed technology provides additional safety because of the higher redundancy. The rear tilt fans can save the VTOL aircraft even in some cases of TEI (two engine inoperative), while providing thrust to fly and land horizontally.

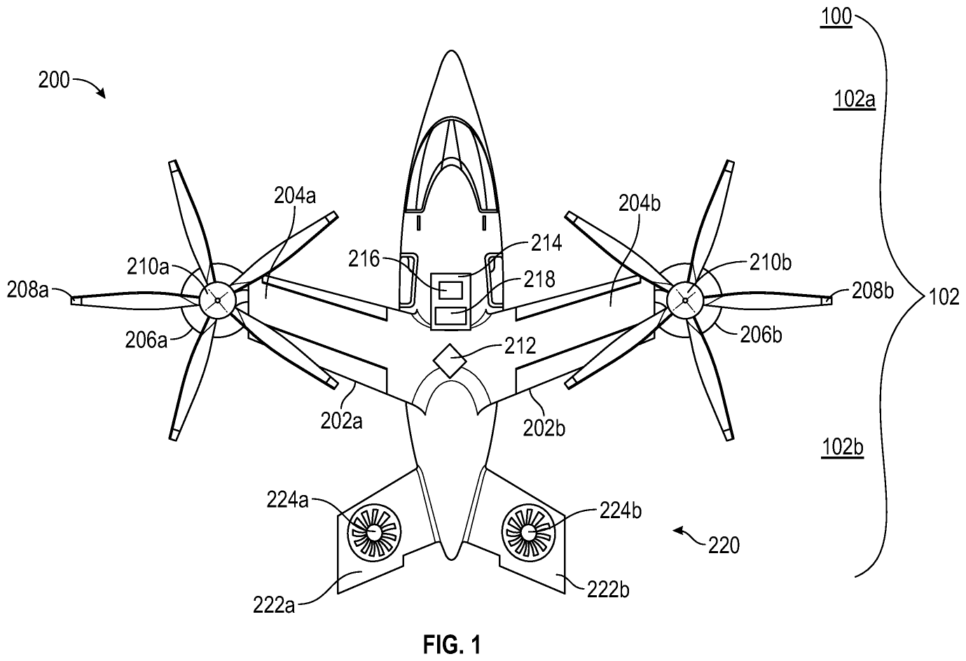

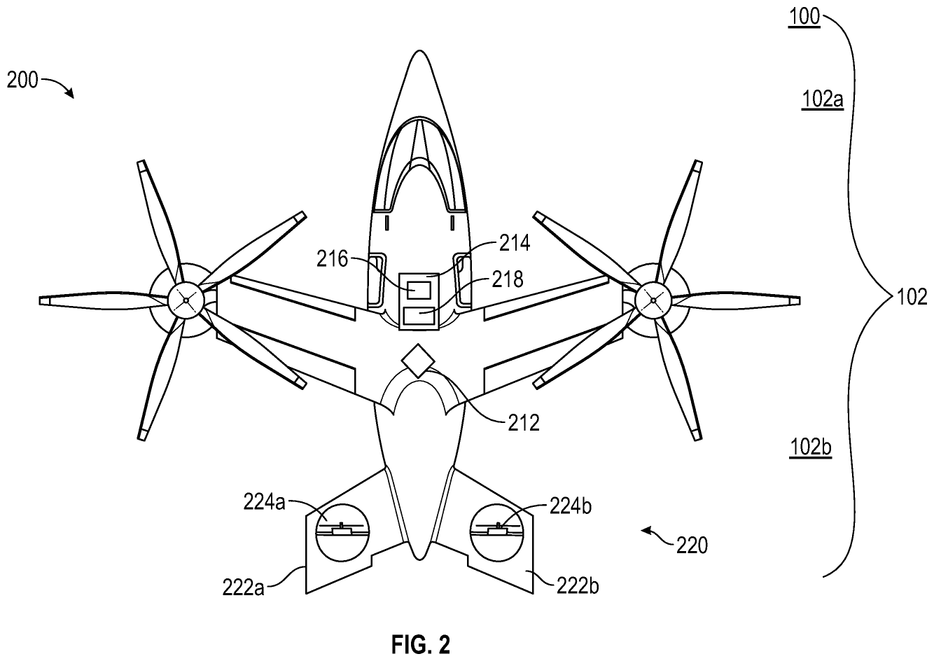

Referring to FIGS. 1-2, there are shown illustrations of an exemplary stabilization system 200 of an aircraft 100 in accordance with aspects of the present disclosure. The aircraft 100 contains a fuselage 102 including a front portion 102a and a rear portion 102b. The stabilization system 200 includes fixed wings 202a, 202b disposed in the front portion 102a of the fuselage 102 and a rear stabilizer system 220 disposed in the rear portion 102b of the fuselage 102.

The fixed wings 202a, 202b contain wing tips 204a, 204b and a sensor 212 onboard to monitor effectiveness levels of propulsion. The wing tips 204a, 204b may include engine nacelles 206a, 206b configured to generate lift. In embodiments, the fixed wings 202a, 202b further includes a driveshaft, a shaft support, and a conversion spindle (not pictured). The rear stabilizer system 220 contains rear rudders 222a, 222b including tilt fans 224a, 224b configured to generate lift. The fuselage 102 is configured to handle high twist torque.

The engine nacelles 206a, 206b include propellors 208a, 208b and rotors 210a, 210b. In embodiments, the engine nacelles 206a, 206b further include pylon mounted driveshafts, proprotor gear boxes, and tilt-axis gearboxes (not pictured). The pylon mounted driveshafts may be orientated parallel or perpendicular to the fuselage, lightweight, and/or configured to produce torque to turn the propellors 208a, 208b.

The engine nacelles 206a, 206b may have a variety of shapes, generally including a substantially oblong or cylindrical shape, and may be made of metals, polymers, composite, and/or any other materials widely utilized in the relevant arts.

The engine nacelles 206a, 206b are powered by a fuel/power source for driving the stabilization system 200. The fuel/power source may include any suitable power source and/or fuel for powering the engines and control systems of the aircraft 100. For example, the stabilization system 200 may include internal combustion engines, hydrogen, and/or electric motors, or any combination thereof.

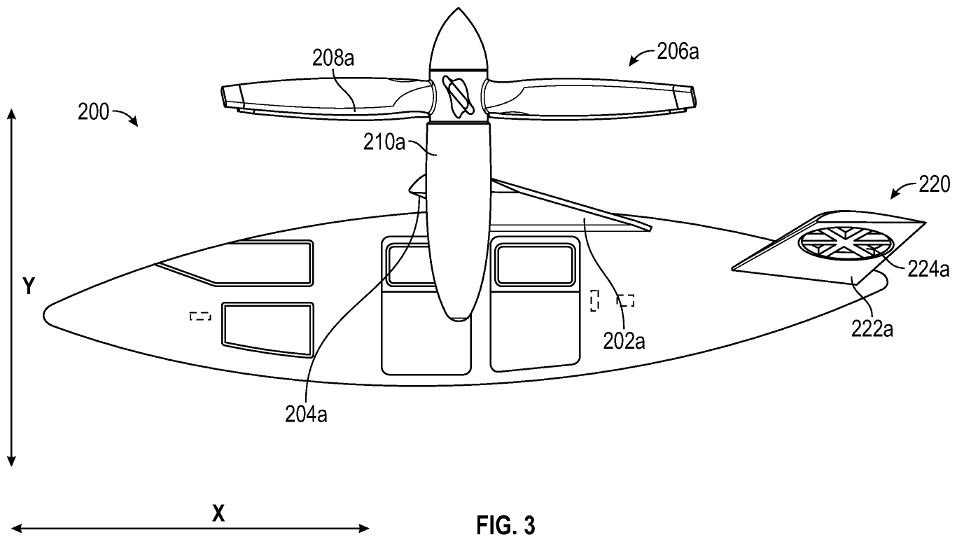

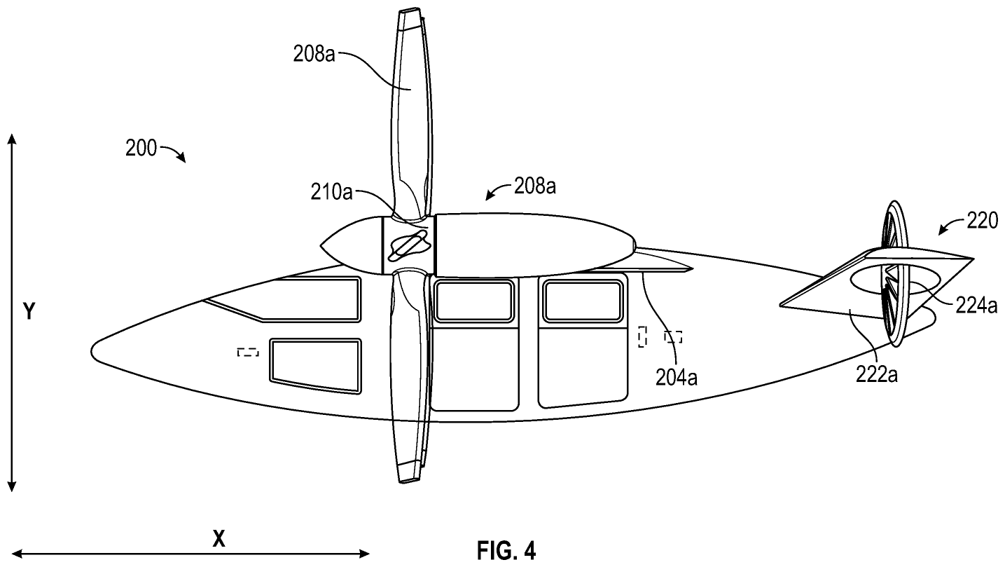

In embodiments, the engine nacelles 206a, 206b may be configured to rotate through an arc length ranging from about zero degrees to about 90 degrees with respect to the fixed wings 202a, 202b. The arc length extends on an axis Y perpendicular to the fixed wings 202a, 202b (FIGS. 3-4). Although the engine nacelles 206a, 206b are described as being able to rotate, it is contemplated that the engine nacelles 206a, 206b may also have a fixed orientation.

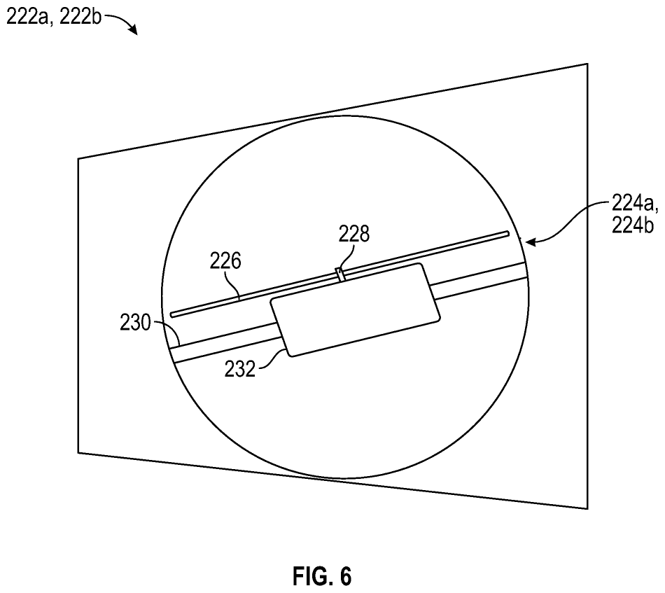

Referring to FIG. 6, the tilt fans 224a, 224b include a fan blade 226, an actuator 228, a shaft 230, and a power control unit (PCU) 232. The tilt fans 224a, 224b may be configured to rotate through an arc length ranging from about zero degrees to about 180 degrees with respect to the rear rudders 222a, 222b. The arc length extends on an axis Y perpendicular to the rear rudders 222a, 222b (FIGS. 3-4). Rotation of the tilt fans 224a, 224b enable motion into a first position and a second position. The tilt fans 224a, 224b are configured to tilt quickly between these positions. The first position is a horizontal position configured to control pitch. The second position is a vertical position configured to control yaw. In aspects, the rear stabilizer system 220 may be capable of tandem and/or counter propulsion. For example, in tandem propulsion, tilt fan 224a is in the first position and tilt fan 224b is in the first position. In counter propulsion, the tilt fan 224a is in the first position, and the tilt fan 224b is in the second position, or vice versa.

At high speeds, the flight dynamics (roll, pitch, yaw) of the aircraft 100 may be controlled through the stabilization system 200. Roll may be controlled by altering the pitch of the wing tips 204a, 204b to increase lift, or altering the position of the engine nacelles 206a, 206b. Further, the pitch and yaw may be controlled by the rear stabilizer system 220 by altering the position of the rear rudders 222a, 222b and/or the tilt fans 224a, 224b.

The sensor 212 is configured to detect a failure condition based on the effectiveness of propulsion and any deviations thereof related to the stabilization system 200. For example, the sensor 212 may detect a one engine inoperative (“OEI”) mode (e.g., “one engine failure” (“OEF”) mode) or a two engine inoperative (“TEI”) mode (e.g., “both engine failure” (“BEF”) or “both engine inoperative” (“BEI”) mode) related to the engine nacelles 206a, 206b. The sensor 212 is connected to a CPU 214 onboard (FIGS. 1-2) having a processor 216 and memory 218. The memory 218 stores instructions which, when executed by the processor 216, cause the system to receive flight data from the sensor 212, determine whether an engine failure exists within the stabilization system 200, and send a signal indicating the engine failure to the rear stabilizer system 220. For example, if a thrust instruction to a propulsion unit is issued by the CPU 214, and the change in flight dynamics (pitch, roll, yaw) or motor speed does not meet a certain threshold value, the sensor 212 may signal a failure condition. In response to this failure condition, the instructions, when executed by the processor 216, may cause the system to send a signal to the rear stabilizer system 220 to adjust the flight dynamics and/or motor speed through additional propulsion. In embodiments, the instructions may further include which side of the fuselage 102 the engine failure is located thereon.

The rear stabilizer system is configured to provide the propulsion necessary to maintain flight. For example, if the sensor 212 detects that one engine nacelle 206a, 206b fails (OEI), the rear rudders 222a, 222b may be set to the first position (horizontal) to create a counter-torque propulsion towards the failed engine nacelle(s) 206a and/or 206b. If both engine nacelles 206a, 206b fail (TEI), the rear rudders 222a, 222b may similarly create propulsion to fly and land horizontally. To try to solve OEI, traditional VTOL aircraft utilize cross-shafts between engines as well as a multitude of gearboxes, which results in a solution that is heavy, complex, and expensive. The solution provided by the disclosed technology provides the benefits of being light weight, much less complex, and less expensive since the disclosed technology does not use cross-shafts.

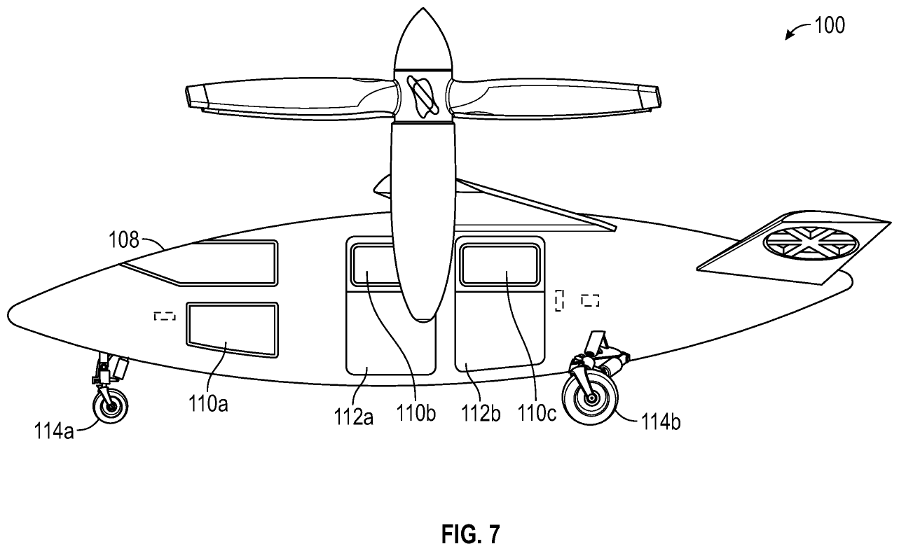

With reference to FIG. 7, there is shown an illustration of an exemplary aircraft 100 in accordance with aspects of the present disclosure. The aircraft 100 generally includes a fuselage 102 configured to carry a crew, a passenger, and/or cargo. The fuselage 102 may include a windshield 108 for visibility of the crew, one or more windows 110a, 110b, 110c for visibility of the passenger and/or the crew, doors 112a, 112b for exit and entry, and landing gear 114a, 114b. The fuselage 102 may have a variety of shapes, generally including a substantially oblong or cylindrical shape, and may be made of metals, polymers, composite, and/or any other materials widely utilized in the relevant arts.

Certain aspects of the present disclosure may include some, all, or none of the above advantages and/or one or more other advantages readily apparent to those skilled in the art from the drawings, descriptions, and claims included herein. Moreover, while specific advantages have been enumerated above, the various aspects of the present disclosure may include all, some, or none of the enumerated advantages and/or other advantages not specifically enumerated above.

The aspects disclosed herein are examples of the disclosure and may be embodied in various forms. For instance, although certain aspects herein are described as separate aspects, each of the aspects herein may be combined with one or more of the other aspects herein. Specific structural and functional details disclosed herein are not to be interpreted as limiting, but as a basis for the claims and as a representative basis for teaching one skilled in the art to variously employ the present disclosure in virtually any appropriately detailed structure. Like reference numerals may refer to similar or identical elements throughout the description of the figures.

The phrases “in an aspect,” “in aspects,” “in various aspects,” “in some aspects,” or “in other aspects” may each refer to one or more of the same or different aspects in accordance with the present disclosure.

It should be understood that the foregoing description is only illustrative of the present disclosure. Various alternatives and modifications can be devised by those skilled in the art without departing from the disclosure. Accordingly, the present disclosure is intended to embrace all such alternatives, modifications, and variances. The aspects described with reference to the attached drawing figures are presented only to demonstrate certain examples of the disclosure. Other elements, steps, methods, and techniques that are insubstantially different from those described above and/or in the appended claims are also intended to be within the scope of the disclosure.

What is claimed is:

1. A stabilization system for an aircraft, comprising:
a rear stabilizer system configured to be disposed in a rear portion of a fuselage of an aircraft, the rear stabilizer system including a rear rudder further including a tilt fan configured to generate lift, wherein the rear stabilizer system is configured to detect a failure of an engine and activate an emergency mode;
a processor; and
a memory, including instructions, which when executed by the processor, cause the system to:
receive flight dynamics from an onboard sensor;
determine an existence and a location of the engine failure; and
send a signal to the rear rudder based on the existence and the location of the engine failure, wherein the rear rudder engages in a first position, and wherein the first position generates counter-torque propulsion towards the engine that failed.

2. The stabilization system of claim 1, wherein the aircraft is a vertical take-off and landing (VTOL) aircraft.

3. The stabilization system of claim 1, wherein the engine failure is at least one of a one engine inoperative (OEI) mode or a two engine inoperative (TEI) mode.

4. The stabilization system of claim 1, wherein propulsion is generated by the tilt fan.

5. The stabilization system of claim 4, wherein the rear stabilizer system is configured to generate tandem propulsion and/or counter propulsion relative to the engine that failed.

6. The stabilization system of claim 1, wherein the tilt fan is configured to rotate through an arc length ranging from about zero degrees to about 180 degrees with respect to the rear rudder.

7. The stabilization system of claim 6, wherein the arc length extends on an axis perpendicular to the rear rudder.

8. The stabilization system of claim 1, wherein the tilt fan is capable of moving into a first position and a second position.

9. The stabilization system of claim 1, further comprising a fixed wing disposed in a front portion of the fuselage of the aircraft, the fixed wing including a wing tip including an engine nacelle configured for generating lift, wherein the engine nacelle includes a rotor.

10. The stabilization system of claim 9, wherein the engine nacelle is configured to rotate through an arc length ranging from about zero degrees to about 90 degrees with respect to the fixed wing.

11. The stabilization system of claim 10, wherein the arc length extends on an axis perpendicular to the fixed wing.

12. A computer-implemented method for a stabilization system for an aircraft, comprising:
receiving flight dynamics from an onboard sensor;
determining an existence and location of a failure of an engine; and
sending a signal to a rear rudder of the aircraft based on the existence and location of the engine failure, wherein the rear rudder engages in a first position, and wherein the first position generates counter-torque propulsion towards the engine that failed.

13. The computer-implemented method of claim 12, wherein the aircraft is a vertical take-off and landing (VTOL) aircraft.

14. The computer-implemented method of claim 12, wherein the engine failure is at least one of a one engine inoperative (OEI) mode or a two engine inoperative (TEI) mode.

15. The computer-implemented method of claim 12, wherein propulsion is generated by a tilt fan.

16. The computer-implemented method of claim 12, wherein the rear stabilizer system is configured to generate tandem propulsion and/or counter propulsion relative to the engine that failed.

17. The computer-implemented method of claim 12, wherein the tilt fan is configured to rotate through an arc length ranging from about zero degrees to about 180 degrees with respect to the rear rudder.

18. The computer-implemented method of claim 17, wherein the arc length extends on an axis perpendicular to the rear rudder.

19. The computer-implemented method of claim 12, wherein the tilt fan is capable of moving into a first position and a second position.

20. A non-transitory computer-readable storage medium storing a program for causing a controller to execute a method for flight stabilization, the method comprising:
receiving flight dynamics from an onboard sensor;
determining an existence and location of a failure of an engine; and
sending a signal to a rear rudder of the aircraft based on the existence and location of the engine failure, wherein the rear rudder engages in a first position, and wherein the first position generates counter-torque propulsion towards the engine that failed.
